(19) United States
(12) Patent Application Publication
(10) Pub. No.: US 2012/0033258 A1
(43) Pub. Date: Feb. 9, 2012

(54) IMAGE PROCESSING APPARATUS, CONTROL METHOD OF IMAGE PROCESSING APPARATUS, AND STORAGE MEDIUM

(75) Inventors: Yusuke Fukasawa, Tokyo (JP); Hajime Ohno, Fujisawa-shi (JP)

(73) Assignee: CANON KABUSHIKI KAISHA, Tokyo (JP)

(21) Appl. No.: 13/197,198

(22) Filed: Aug. 3, 2011

(30) Foreign Application Priority Data
Aug. 6, 2010 (JP) 2010-177316

(51) Int. Cl. G06K 15/02

(52) U.S. Cl. 358/1.15

(57) ABSTRACT

According to the present invention, an external device presents a display instruction for displaying information about application installed on an image processing apparatus together with screen information to the image processing apparatus. The image processing apparatus generates screen information for displaying the information about the application installed therein based on the received display instruction and the screen information, and displays an operation screen based on the screen information.

### BACKGROUND OF THE INVENTION

1. Field of the Invention

The present invention relates to an image processing apparatus, a control method of an image processing apparatus, and a storage medium.

2. Description of the Related Art

Japanese Patent Application Laid-Open No. 2006-127503 discusses conventional art in which an information processing apparatus such as a personal computer (PC) is connected to a web server on a network and an operation screen provided by the web server is displayed on a web browser provided in the information processing apparatus.

According to Japanese Patent Application Laid-Open No. 2006-127503, the web server presents the operation screen for inputting an instruction to use functions provided in a multifunction peripheral (MFP). More specifically, a user of the MFP inputs an instruction to the MFP via the operation screen displayed on the web browser. The input instruction is notified to the web server by the web browser of the MFP. The web server that receives the notification requests the MFP to execute various processing in response to instruction contents input from the user. The MFP that receives the request executes the requested processing. Thus, all menu data for operating the MFP does not need to be stored in the MFP, and the menu data can be easily changed on the web server. According to Japanese Patent Application Laid-Open No. 2006-127503, the server uniformly presents screen information to display a menu screen for operating the MFP. Therefore, it is possible to display a menu screen common to all MFPs.

However, with the method according to Japanese Patent Application Laid-Open No. 2006-127503, it is not possible to display on the menu screen information about application individually installed on the MFP that is not grasped by the web server.

### SUMMARY OF THE INVENTION

The present invention is directed to provide an image processing apparatus to enable proper display of information about application individually installed on the image processing apparatus on an operation screen of the image processing apparatus provided from an external device such as a server.

According to an aspect of the present invention, an image processing apparatus includes a storage unit configured to store information about application installed on the image processing apparatus, a generation unit configured to generate, when the image processing apparatus receives first screen information for operating the image processing apparatus and a display instruction for displaying the information about the application on an operation screen of the image processing apparatus from an external device, second screen information by using the first screen information and the information stored in the storage unit, and a display unit configured to display the operation screen based on the second screen information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a diagram of the entire image processing system according to the present invention.

FIG. 2 illustrates a block diagram of a configuration of a multifunction peripheral (MFP) according to the present invention.

FIG. 3 illustrates a block diagram of a configuration of a web server according to the present invention.

FIG. 4 illustrates a block diagram of a software configuration of the entire image processing system according to the present invention.

FIG. 5 illustrates a flowchart of processing when installing expansion application according to the first exemplary embodiment of the present invention.

FIG. 6 illustrates a diagram of a configuration of a table for managing the expansion application according to the first exemplary embodiment of the present invention.

FIG. 7 illustrates a flowchart of processing when the MFP displays an operation screen according to the first exemplary embodiment of the present invention.

FIGS. 8A to 8C illustrate diagrams of examples of screen information used when displaying the operation screen according to the first exemplary embodiment of the present invention.

FIGS. 9A and 9B illustrate diagrams of examples of the operation screen displayed on the MFP according to the first exemplary embodiment of the present invention.

FIG. 10 illustrates a flowchart of processing when a user selects the expansion application according to the first exemplary embodiment of the present invention.

FIG. 11 illustrates a flowchart of processing when a user selects expansion application according to the second exemplary embodiment of the present invention.

FIG. 12 illustrates a flowchart of processing when an MFP displays an operation screen according to the third exemplary embodiment of the present invention.

FIGS. 13A and 13B illustrate examples of screen information used when displaying the operation screen according to the third exemplary embodiment of the present invention.

FIG. 14 illustrates a diagram of an operation screen displayed on an MFP according to the fourth exemplary embodiment of the present invention.

### DESCRIPTION OF THE EMBODIMENTS

Various exemplary embodiments, features, and aspects of the invention will be described in detail below with reference to the drawings.

The exemplary embodiments do not limit the present invention according to claims. All combinations of features according to the exemplary embodiments may not be necessarily required to solve a problem concerning the present invention.

The first exemplary embodiment of the present invention is described below. According to the first exemplary embodiment of the present invention, a multifunction peripheral (MFP) requests screen information to be displayed on an operation screen of the MFP to a web server on a network. The web server generates the requested screen information, and transmits the screen information to the MFP. The MFP that receives the screen information changes the received screen information according to the installed situation of the application thereof, and displays the changed screen information as the operation screen.

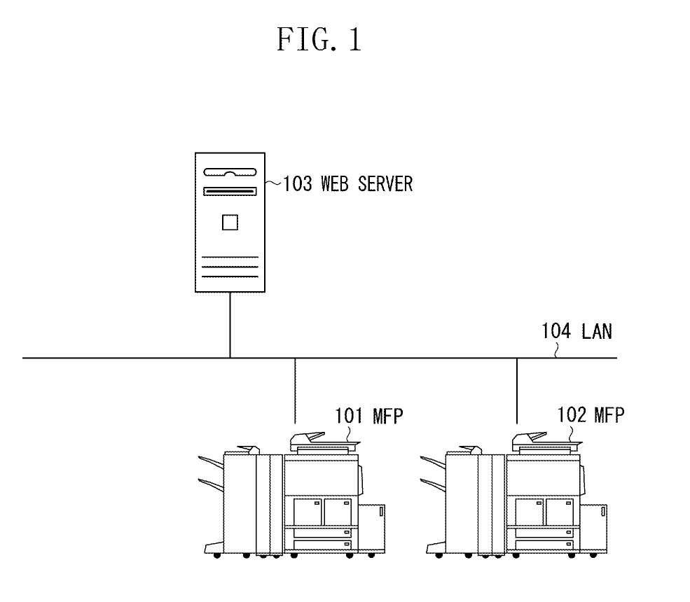

FIG. 1 illustrates the entire information processing system according to the first exemplary embodiment. On a local area network (LAN) 104, a web server 103 is connected to an MFP 101 or an MFP 102 communicable with each other. A connection formed between the web server 103 and the MFP 101 or MFP 102 is not limited to the LAN, and the system can be realized on the Internet or wireless communication, or any connection method. The MFP is described as an example of the image processing apparatus. However, the image processing apparatus according to the present exemplary embodiment is not limited to this, and may be a single function peripheral (SFP), such as a scanner or a printer. Alternatively, the image processing apparatus may be a personal computer (PC) or a mobile phone. The configuration and function of the MFP 102 are similar to those of the MFP 101, and are not described below. Further, the web server is described as an example of the external device. However, the external device according to the present exemplary embodiment is not limited to this and may be another MFP or PC having the web server function.

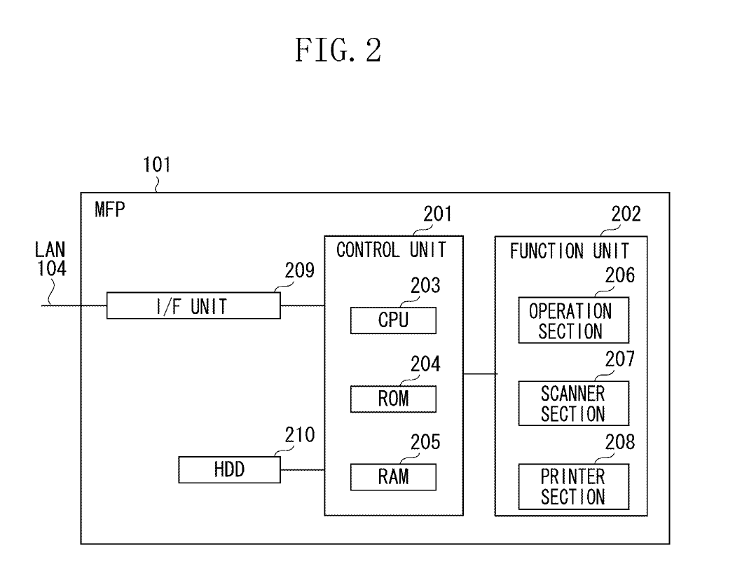

FIG. 2 illustrates a block diagram of an apparatus configuration of the MFP 101. A control unit 201 including a central processing unit (CPU) 203 controls the entire operation of the MFP 101. The CPU 203 reads a control program stored in a read-only memory (ROM) 204 or a hard disk drive (HDD) 210 to execute various controls such as reading control or transmission control. The ROM 204 stores a control program for executing processing of flowcharts, which will be described later. A random access memory (RAM) 205 is used as a temporary storage area such as a main memory or a work area of the CPU 203.

Further, the control unit 201 is connected to a function unit 202 to control operations of an operation section 206, a scanner section 207, and a printer section 208.

The operation section 206 includes a liquid crystal display having a keyboard or a touch panel function. Further, the operation section 206 includes a web browser function. The web browser of the MFP 101 analyzes a hyper-text markup language (HTML) file received from the web server 103, and displays an operation screen based on a description of the analyzed HTML file on the operation section 206.

The scanner section 207 reads a document, generates image data, and inputs the generated image data to the control unit 201. The printer section 208 prints print target image data input from the control unit 201 on a recording medium, such as a sheet.

The interface unit 209 connects the control unit 201 to the LAN 104 to receive image data for printing from the web server 103 and screen data on the operation screen displayed on the operation section 206.

A hard disk drive (HDD) 210 stores a control program for executing processing of flowcharts or an application management table 600, which will be described below.

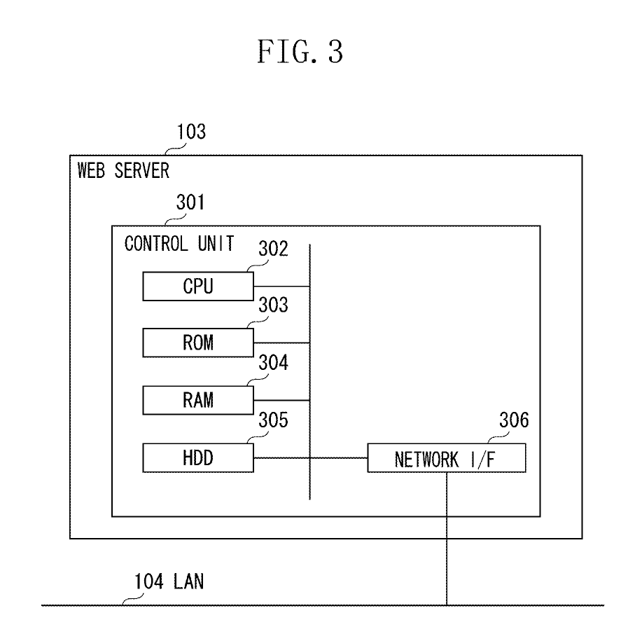

FIG. 3 illustrates a block diagram of an apparatus configuration of the web server 103. A control unit 301 including a central processing unit (CPU) 302 controls the operation of the entire web server 103. The CPU 302 reads a control program stored in a read-only memory (ROM) 303 or an HDD 305, and executes various control processing. A random access memory (RAM) 304 is used as a temporary storage area such as a main memory or a work area of the CPU 302. A network interface (I/F) 306 connects the control unit 301 to the LAN 104. The HDD 305 stores a control program or various web applications.

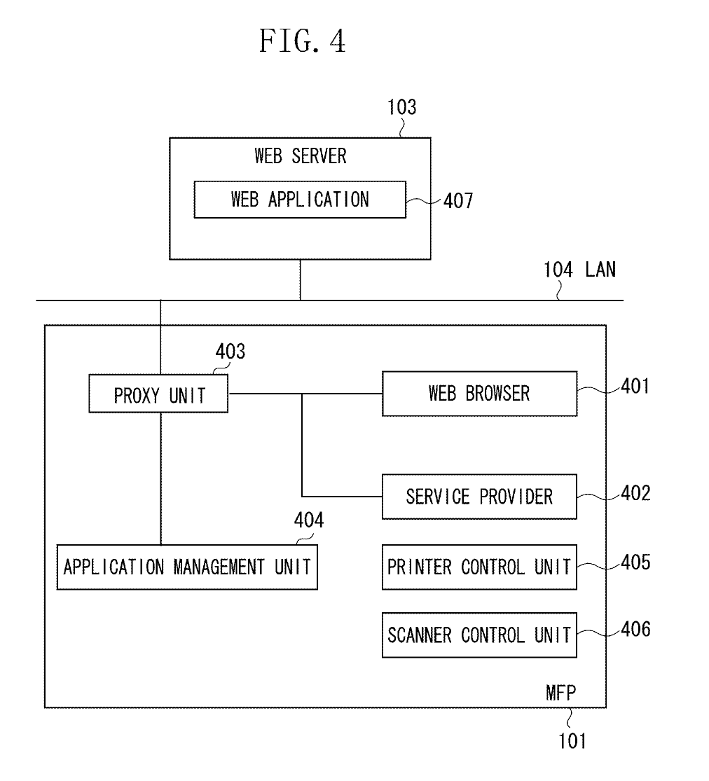

FIG. 4 illustrates a software configuration of the entire information processing system. The software configuration in FIG. 4 is realized by executing the control program by the CPUs provided in the MFP 101 and the web server 103 in FIGS. 2 and 3.

Referring to FIG. 4, the MFP 101 includes a web browser 401, a service provider 402, a proxy unit 403, an application management unit 404, a printer control unit 405, and a scanner control unit 406.

The web browser 401 requests screen information to be displayed on the operation section 206 to the web server 103. The web browser 401 communicates with the web server 103 via the interface 104 and the network I/F 306. The web browser 401 is communicates with the web server 103 via the proxy unit 403. Specifically, the web browser 401 requests the operation screen of the MFP 101 to be displayed on the operation section 206 to the proxy unit 403, or sends a notification to the proxy unit 403 as an instruction from a user input via the operation screen of the MFP 101 displayed on the operation section 206.

The service provider 402 opens a function in the MFP 101 to the web server 103 on the network. The opened function contains, e.g., a function (send function) for sending electronic data obtained by scanning the document with the scanner control unit 406 to another information processing apparatus.

The proxy unit 403 receives a reply from the web server 103 in response to the request to the web server 103, changes contents if necessary, and transmits the changed contents to the web browser 401 or the service provider 402.

The application management unit 404 manages the application installed on the MFP 101. Specifically, the application management unit 404 sends a notification of the installed situation of the application or executes the application designated by the proxy unit 403 in response to the request from the proxy unit 403.

The printer control unit 405 and the scanner control unit 406 control a printer function and a scanner function provided in the MFP 101.

The web server 103 includes web application 407. The web application 407 also includes various web applications provided in the web server 103, and is executed if necessary.

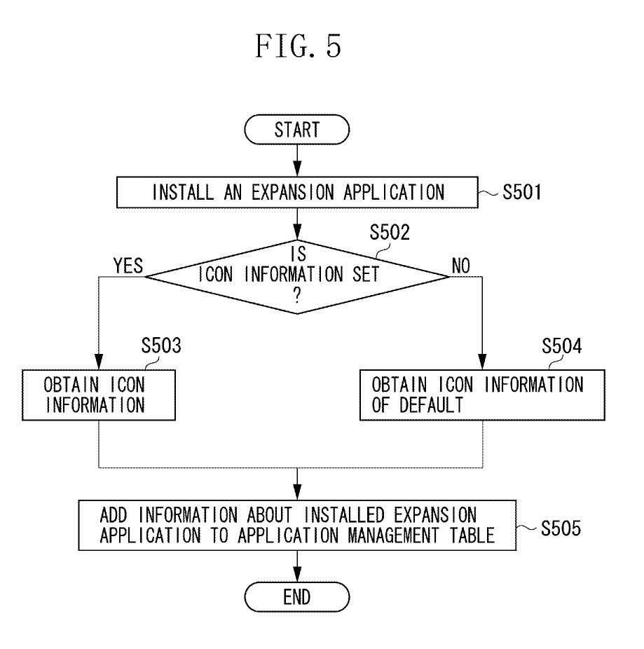

According to the present exemplary embodiment, the MFP 101 can install the application. FIG. 5 illustrates a flowchart of a processing sequence executed when the user installs the application on the MFP 101. Steps S501 to S505 are processed by rasterizing the program stored in a memory such as the ROM to the RAM by the CPU provided in the MFP 101 and executing the program.

In step S501, the MFP 101 installs expansion application for expanding the function of the MFP 101. Instep S502, the application management unit 404 determines whether individual icon information is set to the installed expansion application. The icon information is image information used for generating a button for executing the expansion application when the operation section 206 displays the button. If the individual icon information is set to the installed expansion application, in step S503, the application management unit 404 obtains the icon information. If not so, in step S504, the application management unit 404 obtains default icon information stored in advance in the HDD 210 as the icon information about the installed expansion application.

According to the present exemplary embodiment, the application management unit 404 determines whether the icon information is set to the installed expansion application. However, proper icon information may be displayed for all expansion applications without the determination.

After obtaining the icon information, in step S505, the application management unit 404 adds information about the installed expansion application to an application management table 600, which will be described below. Then, the processing in the present flowchart ends.

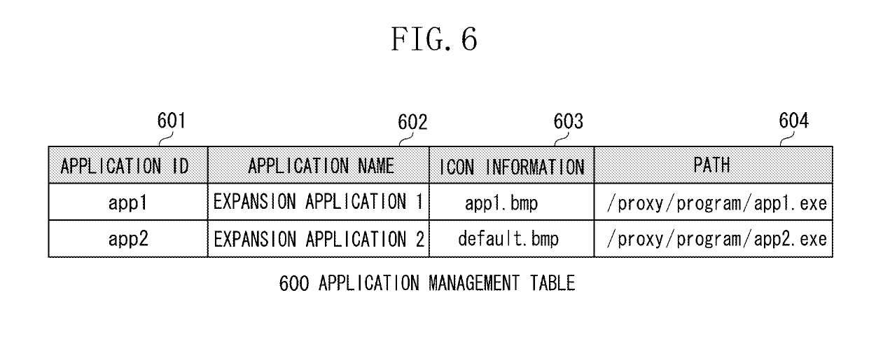

Next, the application management table 600 is described with reference to FIG. 6. The application management table 600 manages the expansion application installed on the MFP 101, and is stored in, i.e., the HDD 210.

The application management table 600 has four attributes of an application ID 601, an application name 602, icon information 603, and a path 604. The application ID 601 indicates a value for identifying the installed expansion application. The application management unit 404 sets a proper value for identifying the installed expansion application when installing the expansion application. The application name 602 is a name of the expansion application. According to the present exemplary embodiment, the operation section 206 displays the application name 602.

The icon information 603 indicates the icon information obtained in step S503 or S504 in FIG. 5. Specifically, image data “appl.bmp” is set as the individual icon information at the installing time in “expansion application 1” of an application identifier (ID) “app1”. Image data “default.bmp” of a default originally provided in the MFP 101 is set as the icon information about “expansion application 2” of an application ID “app2”.

The path 604 indicates an address for storing an execution file for executing the expansion application stored in the application management table 600.

FIG. 6 illustrates an installed state of the two types of the expansion application. According to the present exemplary embodiment, the expansion application is not limited to the two types. When installing additional expansion application, information is added to the application management table 600. When deleting the expansion application, information about the corresponding expansion application is deleted from the application management table 600.

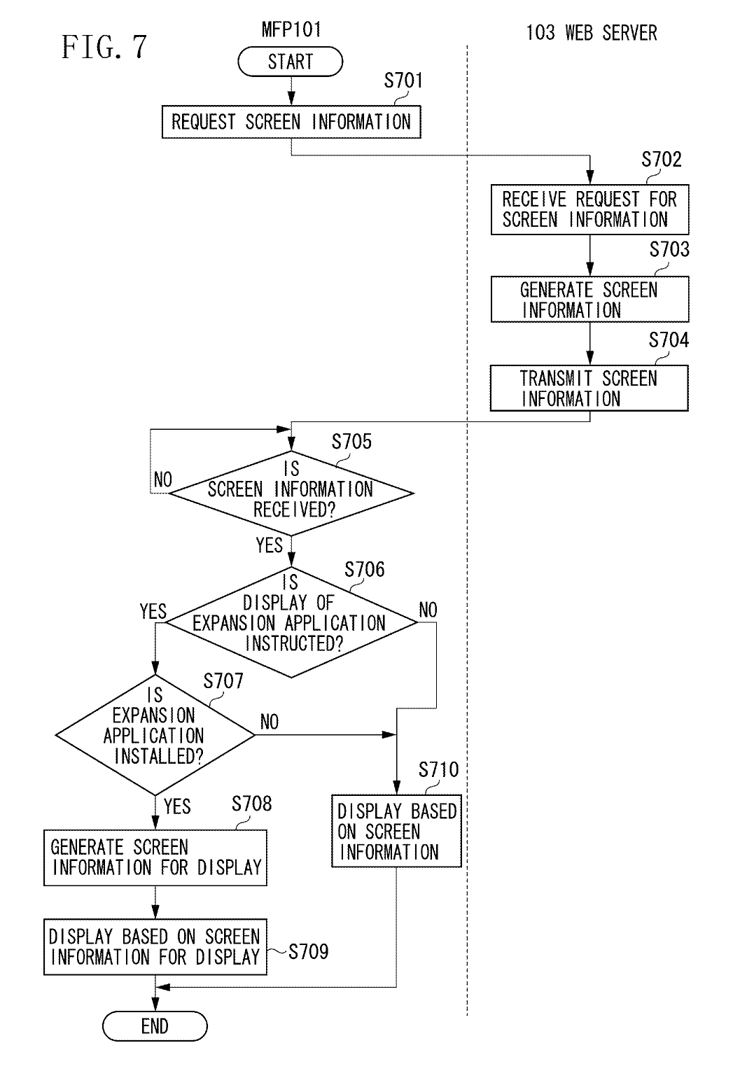

FIG. 7 illustrates a flowchart of a processing sequence when the MFP 101 requests the screen information to the web server 103 and the MFP 101 displays the operation screen in response to the request based on the screen information transmitted from the web server 103. Steps S701 to S710 are processed by rasterizing the program stored in the memory such as the ROM to the RAM and executing the program by the CPU provided in the MFP 101 or the web server 103.

In step S701, the MFP 101 requests the screen information used for display on the operation section 206 to the web server 103. The screen information is requested when the MFP 101 starts or the screen is shifted to another one by the user operation, and is transmitted to the web server 103 via the LAN 104 via the interface unit 209.

In step S702, the web server 103 receives the request of the screen information transmitted from the MFP 101. In step S703, the web server 103 generates the screen information.

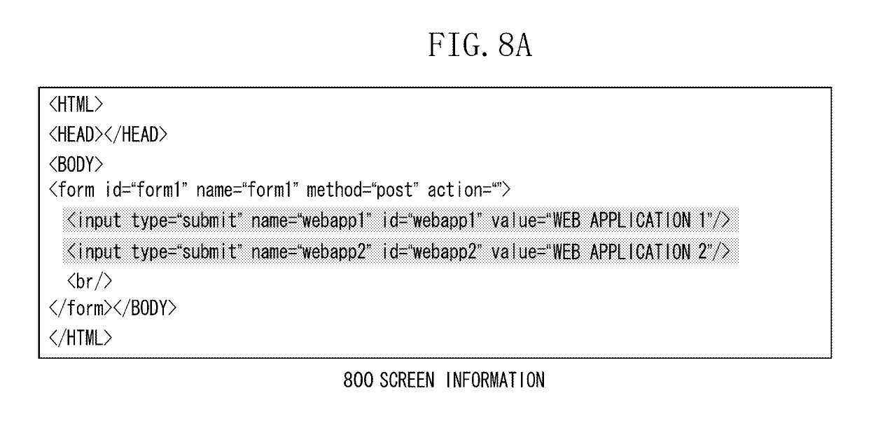

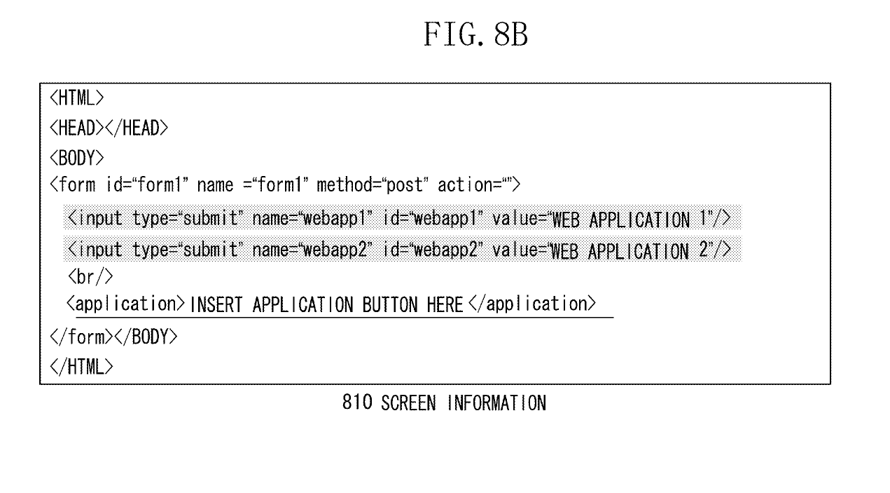

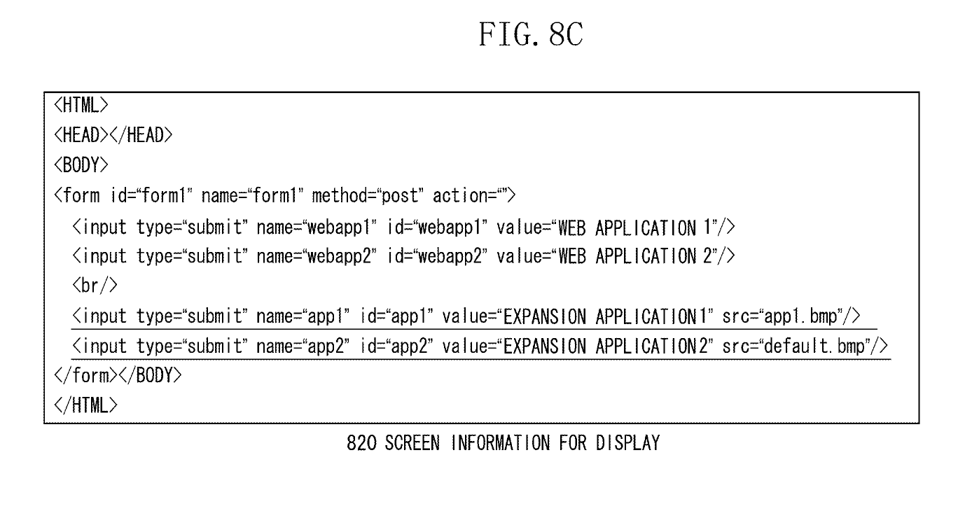

The screen information generated in step S703 is specifically described with reference to FIGS. 8A and 8B. Screen information 800 is an example of the screen information generated in step S703. Two components illustrated by an <input> tag with hatching are information for generating a button for executing the web application managed by the web application 407. The screen information 800 shows that buttons for executing two web application of web application 1 and web application 2 are generated.

An <application> tag is described in the screen information 810 in addition to the screen information 800. An underlined <application> tag is an original tag provided to realize the present exemplary embodiment. When displaying the button for executing the expansion application provided in the MFP 101 on the screen information to be transmitted to the MFP 101, the <application> tag is described as a display instruction of the expansion application. If the screen information includes the <application> tag, it is required to prearrange a rule for displaying the button for executing the expansion application provided in the MFP 101, between the MFP 101 and the web server 103.

Referring back to the flowchart, in step S704, the web server 103 transmits the screen information generated in step S703 to the MFP 101.

In step S705, the CPU 203 determines whether the MFP 101 has received the screen information via the interface unit 209. When the CPU 203 determines that the MFP 101 has received the screen information (YES in step S705), the processing proceeds to step S706. When the CPU 203 determines that the MFP 101 has not received the screen information (NO in step S705), the CPU 203 waits until receiving the screen information.

In step S706, the CPU 203 determines whether the received screen information includes an instruction for displaying the expansion application. According to the present exemplary embodiment, the <application> tag is used as the instruction for displaying the expansion application. Therefore, the CPU 203 determines whether the <application> tag is present or absent. The instruction for displaying the expansion application is not limited to the <application> tag. A script may be embedded as an execution command in a hypertext markup language (HTML) file, or the execution command may be received as another file.

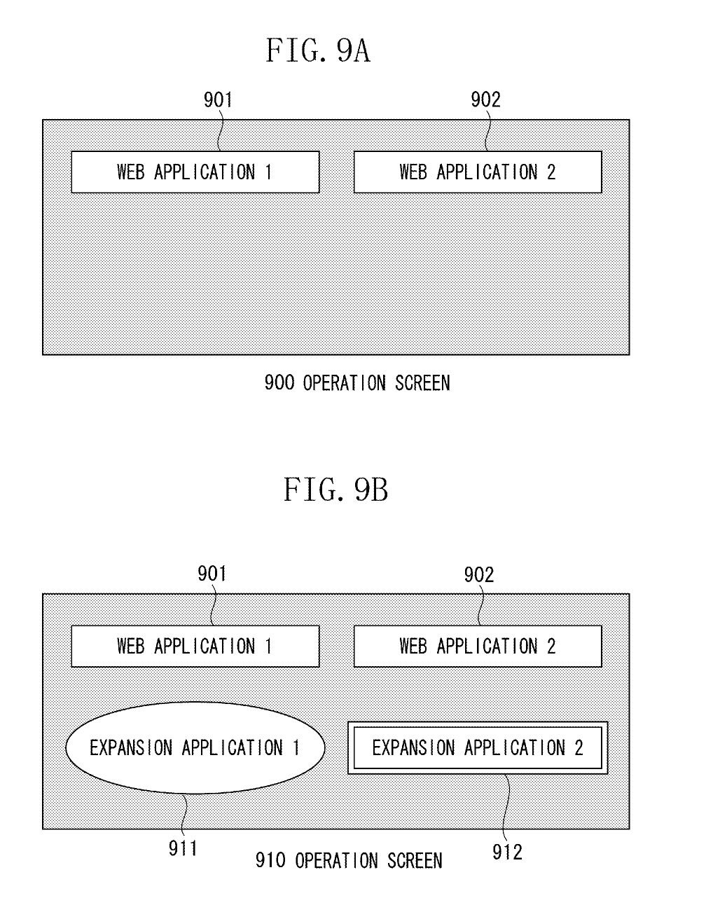

When the CPU 203 determines that the screen information does not include the <application> tag, in other words, the screen information 800 is received (NO in step S706), in step S710, the operation section 206 displays the operation screen based on the screen information 800. FIG. 9A illustrates the operation screen displayed at this time.

An operation screen 900 in FIG. 9A is displayed on the operation section 206 in step S710. Since the screen information 800 does not include the <application> tag, a button 901 and a button 902 are displayed to execute the web application 1 and the web application 2.

On the other hand, when the CPU 203 determines that the screen information includes the <application> tag, in other words, the screen information 810 is received (YES in step S706), in step S707, the application management unit 404 determines whether the expansion application is installed on the MFP 101. Since the user arbitrarily installs the expansion application, the expansion application may not be installed depending on the MFP 101. The processing in step 707 is performed in consideration of this determination.

When the CPU 203 determines that the expansion application is not installed on the MFP 101 (NO in step S707), the processing advances to step S710 and the operation section 206 displays an operation screen 900 based on the screen information 810. At this time, the proxy unit 403 may erase the <application> tag of the screen information 810 or may be displayed as it is if there is no influence on the operation screen 900. On the other hand, when the CPU 203 determines that the expansion application is installed on the MFP 101 (YES in step S707), the processing advances to step S708 and the proxy unit 403 generates screen information for display.

The screen information for display generated in step S708 will be specifically described using screen information 820 for display in FIG. 8C. The screen information 820 for display is generated using the screen information 810 and information about the expansion application of the MFP 101 stored in the application management table 600. Specifically, the MFP 101 rewrites the portion of the <application> tag of the screen information 810, and generates the screen information 820 for display. The rewriting result is an underlined description of the screen information 820 for display. The FIG. 8C shows that an <input> tag for displaying a button for executing the two expansion application of the expansion application 1 and the expansion application 2 is generated using the application ID 601, the application name 602, and the icon information 603.

Referring back to the flowchart, when the screen information 820 for display is generated (YES in step S708), in step S709, the operation section 206 displays the operation screen based on the screen information 820 for display.

FIG. 9B illustrates an example of a screen displayed on the operation section 206. An operation screen 910 is displayed based on the screen information 820 for display. The operation screen 910 displays buttons 901, 902, 911, and 912 for executing the web application 1, the web application 2, the expansion application 1, and the expansion application 2, respectively. The buttons 911 and 912 are generated in step S708, and are displayed as images corresponding to the icon information 603 stored in the application management table 600.

According to the present exemplary embodiment, the <application> tag is used as a display instruction of the expansion application. Further, if a rule is set in advance between the MFP 101 and the web server 103, another tag may be used. As a method for displaying the expansion application at the time of rule setting, the expansion application may be sorted and displayed by an application name or installed date and time.

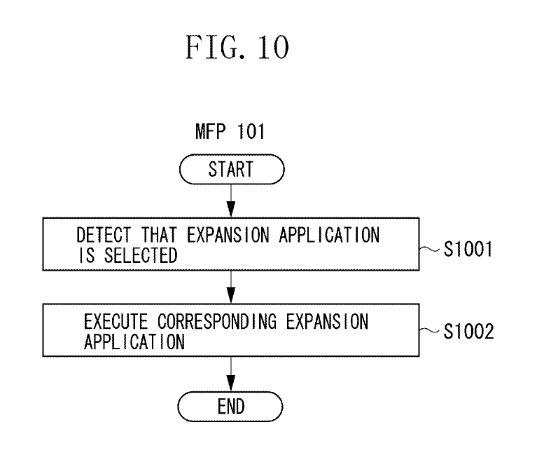

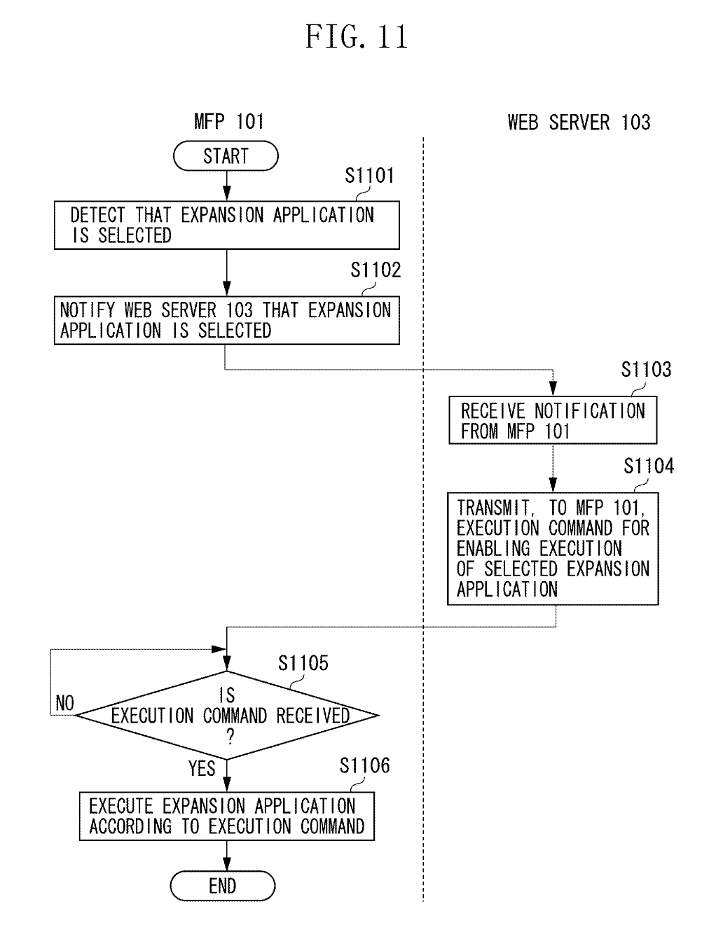

FIG. 10 illustrates processing executed when the user selects the button generated instep S708, i.e., the button 911 or 912. Steps S1001 and S1002 are processed by rasterizing the program stored in the memory such as the ROM to the RAM and executing the program by the CPU provided in the MFP 101.

In step S1001, when the web browser 401 detects that the user selects the button 911 or 912, a value of an id attribute of an <input> tag of the screen information 820 for display is notified to the proxy unit 403.

In step S1002, the proxy unit 403 gives notification to the application management unit 404 to execute the expansion application corresponding to the notified id attribute, and the application management unit 404 executes the corresponding expansion application.

According to the present exemplary embodiment, the screen information presented from the web server 103 is rewritten and information for displaying the button for executing the expansion application individually installed on the MFP 101 is added. Thus, the expansion application individually installed on the MFP 101 is properly displayed on the screen presented from the web server 103.

According to the first exemplary embodiment, as illustrated in the flowchart in FIG. 10, when the user selects the button 911 or 912, the MFP 101 itself detects the selection, and executes the corresponding expansion application. On the other hand, according to the second exemplary embodiment, the MFP 101 notifies the web server 103 of the fact that the user selects the button 911 or 912, and the web server 103 transmits an execution command for executing the corresponding expansion application. The processing is described with reference to a flowchart in FIG. 11. Steps S1101 to S1106 are executed by rasterizing the program stored in the memory such as the ROM to the RAM and executing the program by the CPU provided in the MFP 101 or the web server 103.

In step S1101, the web browser 401 detects that the user selects the button 911 or 912. Then, the web browser 401 notifies the proxy unit 403 of a value of the id attribute of the <input> tag of the screen information 820 for display.

In step S1102, the proxy unit 403 notifies the web server 103 of the fact that the user has selected the expansion application having the notified id attribute. In step S1103, the web server 103 receives the notification. In step S1104, the web server 103 generates an execution instruction for executing the notified expansion application corresponding to the id attribute, and transmits the instruction to the MFP 101.

In step S1105, the CPU 203 determines whether the MFP 101 has received the execution instruction transmitted from the web server 103 via the interface unit 209. When the CPU 203 determines that the MFP 101 has received the execution instruction (YES in step S1105), the processing advances to step S1106. When the CPU 203 determines that the MFP 101 has not received the execution instruction (NO in step S1105), the CPU 203 waits until receiving the execution instruction.

In step S1106, the proxy unit 403 analyzes the received execution instruction, and the application management unit 404 executes the corresponding expansion application.

According to the present exemplary embodiment, it is notified to the web server 103 that the user selects the button 911 or 912, in other words, the user selects the expansion application provided in the MFP 101. As a consequence, the web server 103 grasps a state of the MFP 101 (transition situation of the screen or installed situation of the expansion application), and performs proper processing if necessary.

According to the first and second exemplary embodiments, the expansion application individually installed on the MFP 101 is displayed on the screen presented from the web server 103. Since the type of the expansion application displayed at this time is not limited, all the expansion applications installed on the MFP 101 are displayed. However, the type of the expansion application can be limited by a system administrator depending on a case, such as where only necessary expansion application should be displayed. According to the third exemplary embodiment, in consideration of this point, when the type of the displayed expansion application is designated, the expansion application can be properly displayed.

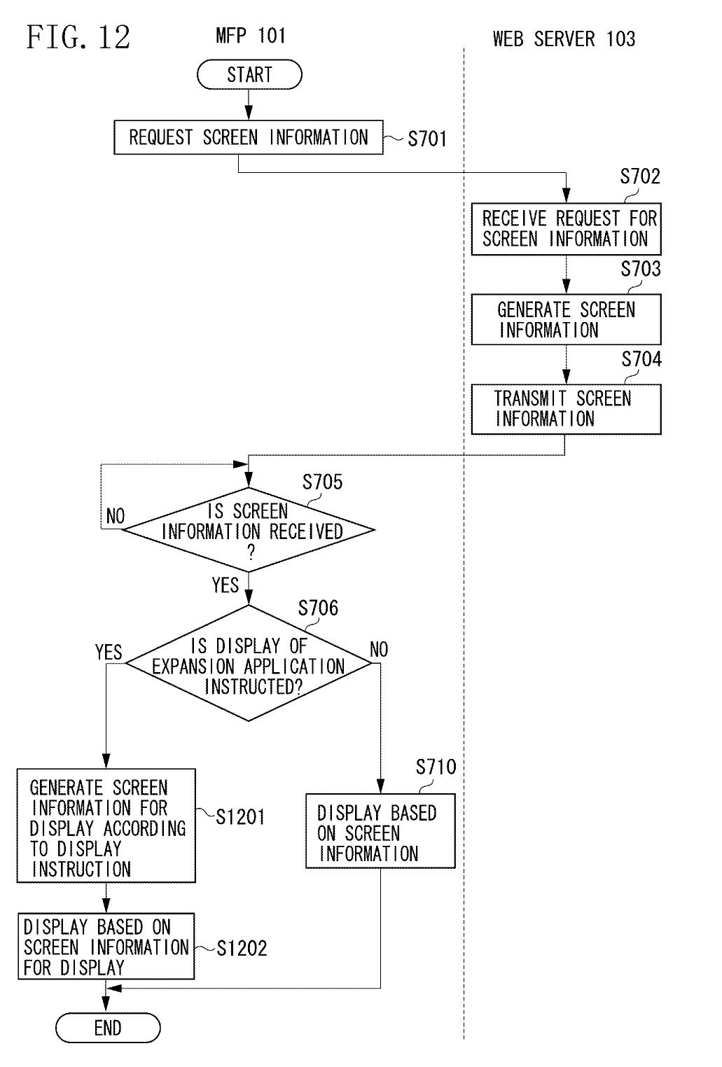

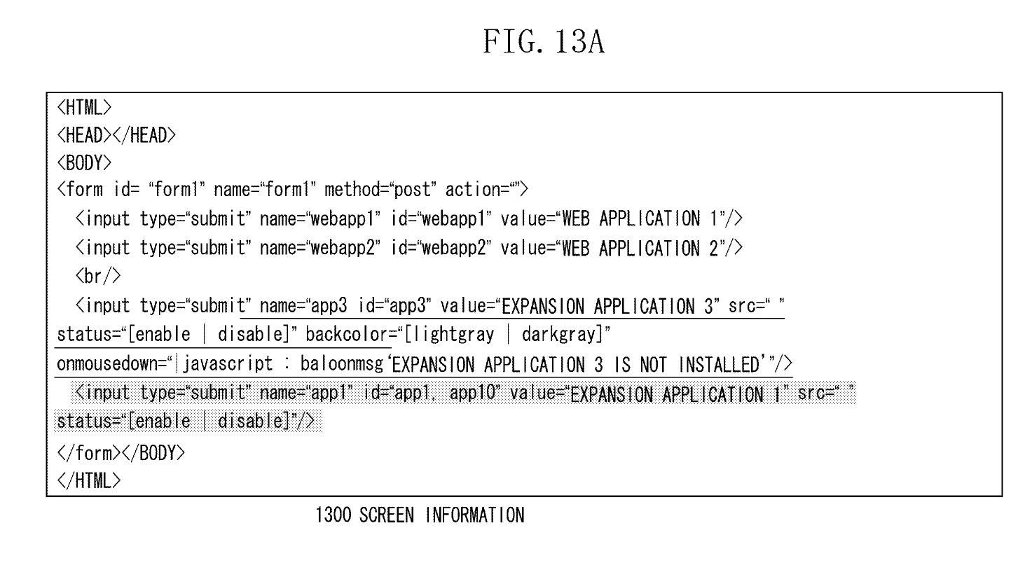

According to the present exemplary embodiment, the MFP 101 requests the screen information to the web server 103. FIG. 12 illustrates a flowchart of a processing sequence in response to the request when the MFP 101 displays the operation screen based on the screen information transmitted from the web server 103. Steps in FIG. 12 are processed by rasterizing the program stored in the memory such as the ROM to the RAM and executing the program by the CPU provided in the MFP 101 or the web server 103. In the step having the same number as that of the flowchart in FIG. 7, the similar processing to FIG. 7 is performed and is not therefore described.

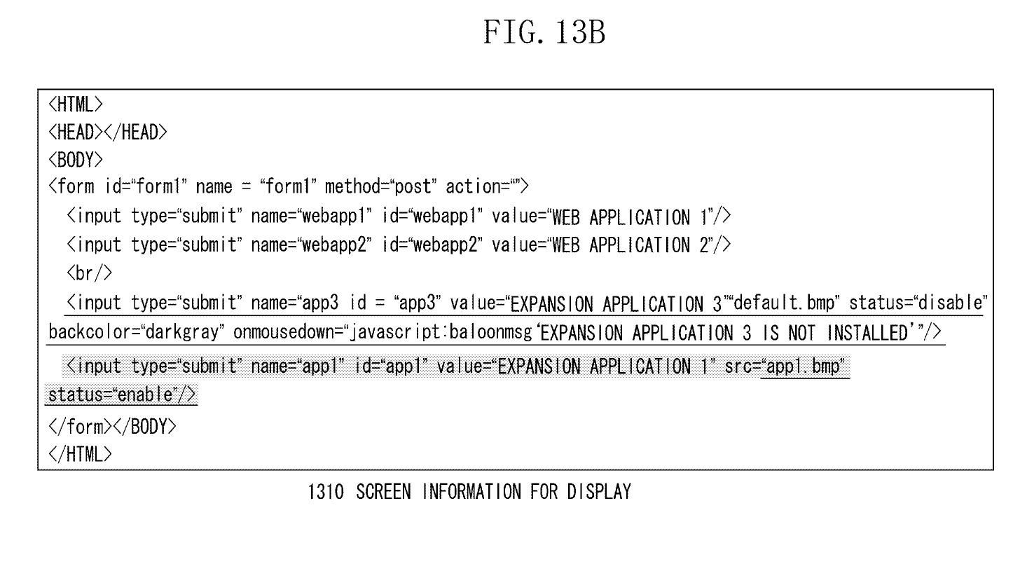

An example is described in which the MFP 101 receives the screen information from the web server 103 in step S705 by using screen information 1300 in FIG. 13A.

The expansion application 1 and the expansion application 3 are described in the screen information 1300. It shows that even if another expansion application is installed on the MFP 101, it is not displayed. With a description of an underlined and hatched portion in the screen information 1300, it is possible to designate a display method of the expansion application 1 and the expansion application 3.

The underlined portion indicates processing corresponding to the install situation of the expansion application 3 of the MFP 101. A status attribute, a backcolor attribute, and onmousedown attribute are segmented by a vertical bar ‘|’. If the expansion application 3 is installed on the MFP 101, a value on the left of the vertical bar ‘|’ is used. If the expansion application 3 is not installed on the MFP 101, a value on the right of the vertical bar ‘|’ is used. As a consequence, even if the expansion application 1 is not installed on the MFP 101, proper display is possible.

In the hatched portion, two values of app1 and app10 are described as the id attribute. The description aims to check whether to install the expansion application having the id attribute described from the left in order and display the expansion application that is confirmed to be first installed. Thus, even if different expansion application having a similar function is installed, it can be displayed to enable the user to recognize the expansion application as having the similar function.

According to the present exemplary embodiment, a description segmented by the vertical bar ‘|’ or a plurality of values of the id attribute is a display instruction of the expansion application.

In step S1201, the proxy unit 403 generates the screen information for display in response to the instruction to display the expansion application included in the screen information received from the web server 103. Screen information 1310 for display in FIG. 13B is generated using the screen information 1300 and the application management table 600 in step S1201.

According to the application management table 600, the expansion application 3 is not installed on the MFP 101. Therefore, a value on the right of the vertical bar ‘|’ is used in the screen information 1300. As a consequence, the underlined description of the screen information 1310 for display is used. Further, according to the application management table 600, the expansion application 1 is installed on the MFP 101. Therefore, the hatched description of the screen information 1310 for display is used.

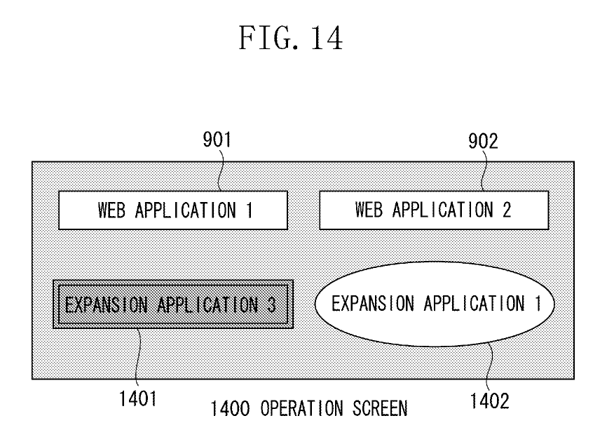

In step S1201, the screen information 1310 for display is generated. In step S1202, the operation section 206 displays the operation screen based on the screen information for display. FIG. 14 illustrates the operation screen displayed at this time on an operation screen 1400. Since the expansion application 3 is not installed on the MFP 101, it is notified to the user that the expansion application 3 is not installed by changing the color of a button 1401. Owing to the description of onmousedown attribute, the user selects the button 1401 and “The expansion application 3 is not installed” is displayed. On the other hand, a button 1402 is displayed, corresponding to a portion indicated by the hatching of the screen information 1310 for display.

According to the present exemplary embodiment, even when the type of the displayed expansion application is designated, the expansion application is properly displayed. The present exemplary embodiment is only an example, and a script may be embedded as a display instruction in a hypertext markup language (HTML) file, or a display instruction may be received as another file. Various display methods can be designated, e.g., the “Display surely the designated expansion application on the upper left on the screen”.

### Other Embodiments

According to the first to third exemplary embodiments, the screen information received by the MFP 101 from the web server 103 includes information for displaying the web application provided in the web server 103. However, the present invention is not limited to this. When the web server 103 transmits web contents as a display screen to the MFP 101, if the expansion application provided in the MFP 101 should be displayed on the display screen, the present invention can be applied.

Aspects of the present invention can also be realized by a computer of a system or apparatus (or devices such as a CPU, a micro-processing unit (MPU), and/or the like) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., a computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-177316 filed Aug. 6, 2010, which is hereby incorporated by reference herein in its entirety.

What is claimed is:

1. An image processing apparatus comprising:
a storage unit configured to store information about application installed on the image processing apparatus;
a generation unit configured to generate, when the image processing apparatus receives first screen information for operating the image processing apparatus and a display instruction for displaying the information about the application on an operation screen of the image processing apparatus from an external device, second screen information by using the first screen information and the information stored in the storage unit; and
a display unit configured to display the operation screen based on the second screen information.

2. The image processing apparatus according to claim 1, further comprising:
a determination unit to determine whether the storage unit stores the information about the application,
wherein, when the determination unit determines that the storage unit does not store the information about the application, the display unit displays the operation screen based on the first screen information without generating the second screen information by the generation unit.

3. The image processing apparatus according to claim 1, wherein the display instruction is included in the first screen information.

4. The image processing apparatus according to claim 1, wherein the first screen information includes information for displaying application provided in the external device.

5. The image processing apparatus according to claim 1, wherein the second screen information includes a button for executing the application installed on the image processing apparatus.

6. The image processing apparatus according to claim 5, wherein the display instruction designates a type of the button to be displayed by the display unit.

7. The image processing apparatus according to claim 5, wherein the display instruction designates a display method of the button.

8. The image processing apparatus according to claim 5, further comprising:
an execution unit configured to, when a user selects the button from the operation screen displayed by the display unit, execute the application corresponding to the button.

9. The image processing apparatus according to claim 5, further comprising:
a notification unit configured to, when a user selects the button from the operation screen displayed by the display unit, notify the external device of the selection of the button,
a reception unit configured to receive an execution instruction to execute the application corresponding to the button from the external device that receives the notification of the notification unit; and
an execution unit configured to execute the application when the reception unit receives the execution instruction.

10. A control method of an image processing apparatus, the control method comprising:
storing information about application installed on the image processing apparatus;
generating, when the image processing apparatus receives first screen information for operating the image processing apparatus and a display instruction for displaying the information about the application on an operation screen of the image apparatus from an external device, second screen information by using the first screen information and the stored information about application installed on the image processing apparatus; and
displaying the operation screen based on the second screen information.

11. A storage medium that stores a program for causing a computer to execute the control method of the image processing apparatus according to claim 10.
